(19) United States
(12) Patent Application Publication
(10) Pub. No.: US 2014/0023105 A1
(43) Pub. Date: Jan. 23, 2014

(54) Device for deflecting laser radiation, and laser device having such a device

(71) Applicants: Aleksei Mikhailov, Dortmund (DE); Aliaksei Krasnaberski, Dortmund (DE); Yuri Kolotushkin, St. Petersburg (RU)

(72) Inventors: Aleksei Mikhailov, Dortmund (DE); Aliaksei Krasnaberski, Dortmund (DE); Yuri Kolotushkin, St. Petersburg (RU)

(73) Assignee: LIMO Patentverwaltungs GmbH & Co. KG, Dortmund (DE)

(21) Appl. No.: 14/003,098

(22) PCT Filed: Mar. 15, 2012
(86) PCT No.: PCT/EP2012/054608

§ 371 Date: Sep. 22, 2013

(30) Foreign Application Priority Data
Mar. 29, 2011 (DE) 10 2011 015 411.6

(51) Int. Cl. H01S 3/063

(52) U.S. Cl. CPC H01S 3/063
USPC 372/64

(57) ABSTRACT

A device for deflecting laser radiation (8) with a waveguide (1) having an entrance face (6) and an exit face (7) spaced apart from each other in the Z-direction by a spacing (L), wherein the waveguide (1) has a greater extent in the X-direction than in the Y-direction, and at least two electrodes (4, 5) arranged on the waveguide (1), wherein a deflection voltage (+V, −V) is applied to the at least two electrodes (4, 5), so that the laser radiation is electro-optically deflected in the waveguide (1) with respect to the X-direction, wherein the spacing (L) between entrance face (6) and exit face (7) has a dimension so that the profile of the laser radiation after exiting the exit face (7) corresponds to the profile of the laser radiation prior to entering the entrance face (6). The spacing (L) may correspond to the Talbot length of the laser radiation.

The present invention relates to a device for deflecting laser radiation according to the preamble of claim 1 and a laser device according to the preamble of claim 10.

Definitions: In the propagation direction of the laser radiation refers to an average propagation direction of the laser radiation, in particular, when the laser radiation is not a plane wave or is at least partly diverging. Laser beam, light beam, sub-beam, or ray, unless expressly stated otherwise, does not refer to an idealized beam of the geometrical optics, but rather a real light beam, such as for example a laser beam that does not have an infinitely small beam cross-section, but rather an extended beam cross-section.

A device of the aforementioned type is known, for example, from U.S. Pat. No. 6,449,084 B1. The device described therein includes a waveguide in the form of a cuboid which has a substantially greater extent in a first transverse direction than in a second transverse direction perpendicular to the first transverse direction. Thus, a substantially planar geometry is obtained, wherein electrodes for deflecting the laser radiation are arranged on the large flat sides. The main advantage of the substantially planar geometry is the significant reduction of the control voltage in spite of large possible deflection angles.

The disadvantage of this conventional waveguide geometry is the distortion of the transverse profile of the laser beam bundle while propagating through the waveguide. Since the profile of the laser beam bundle at the output represents the superposition of the modes of the waveguide and since the phase relationship between different modes changes during propagation through the waveguide, the profile of the laser beam bundle after emerging from the waveguide is different from the profile of the laser beam bundle prior to entering the waveguide. This is indicated in FIG. 4 by the diverging laser radiation 8′, 8″ after passing through the waveguide 1′.

The problem addressed by the present invention is to provide a device of the aforedescribed type that may prevent or at least reduce a change in the profile of the laser radiation. Furthermore, a laser device having such a device is to be disclosed.

This is attained according to the invention with a device of the aforementioned type with the characterizing features of claim 1 and a laser device having the characterizing features of claim 10. The dependent claims relate to preferred embodiments of the invention.

According to claim 1, the distance between the entrance face and the exit face of the at least one waveguide has in the first direction a dimension such that the profile of the laser radiation after exiting from the exit face corresponds to the profile of the laser radiation prior to entering the entrance face. By maintaining the profile of the laser radiation, for example two mutually perpendicular waveguides can be arranged sequentially so as to deflect the laser radiation in two mutually perpendicular directions. Possible applications are, for example, the horizontal and the vertical deflection in a laser television set. Furthermore, the shape of the electrodes can be selected relatively freely due to the preservation of the profile.

In particular, the distance between the entrance face and the exit face of the at least one waveguide corresponds in the first direction to the Talbot length or an integer multiple of the Talbot length for light with the wavelength of the laser radiation to be deflected. In this way, the profile of the laser radiation is conserved through external geometrical specifications.

Alternatively, the distance between the entrance face and the exit face of the at least one waveguide may correspond in the first direction to one half of the Talbot length or to an odd multiple of half the Talbot length for light with the wavelength corresponding to the laser radiation to be deflected.

Preferably, the Talbot length L_{T} is:

L_{T}=8 nD²/λ₀,
wherein n is the refractive index of the at least one waveguide,
D is the extent of the at least one waveguide in the third direction, and
λ₀ is the vacuum wavelength of the laser radiation to be deflected.

According to claim 10, the laser device is characterized in that the device for deflecting laser radiation is a device according to the invention.

Additional features and advantages of the present invention will become apparent from the following description of preferred exemplary embodiments with reference to the appended drawings, which show in:

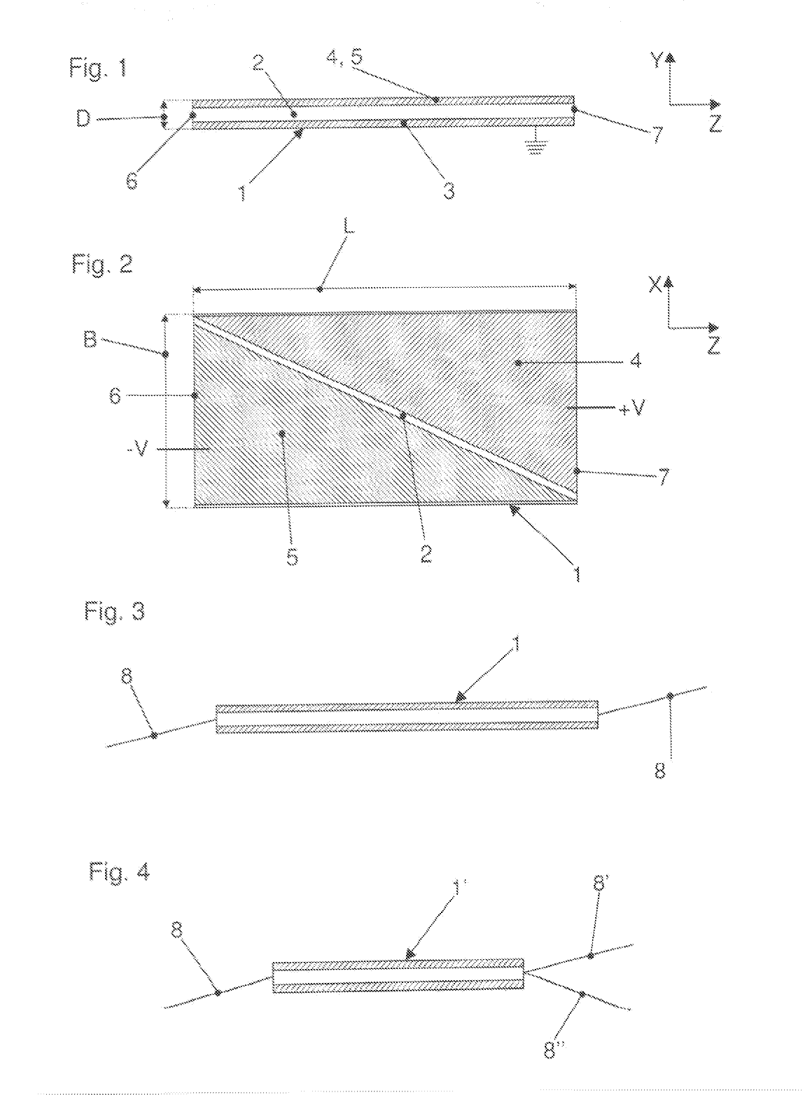

FIG. 1 a schematic side view of a first embodiment of a device according to the invention;

FIG. 2 a plan view on the device of FIG. 1;

FIG. 3 a schematic side view corresponding to FIG. 1 with a schematically indicated laser beam;

FIG. 4 a schematic side view corresponding to FIG. 1 of a prior art device;

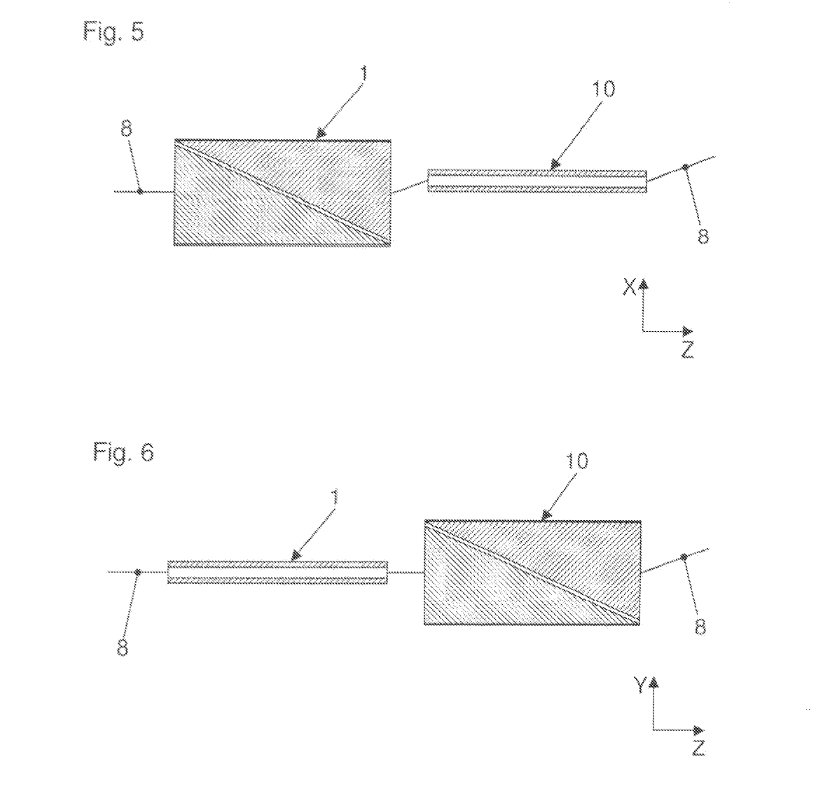

FIG. 5 a schematic side view of a second embodiment of a device according to the invention; and

FIG. 6 a plan view on the device of FIG. 5.

For the purpose of illustration, a Cartesian coordinate system is shown in several of the figures. Furthermore, identical or functionally equivalent parts are designated in the figures by like reference numerals.

The embodiment of a device according to the invention shown in FIGS. 1 and 2 includes a waveguide 1 having a transparent substrate 2 and a plurality of thin, flat electrodes 3, 4, 5. The electrodes 3, 4, 5 can either be applied to the substrate 2 directly, or may each be separated from the substrate 2 by one or more suitable intermediate layers.

The substrate is in the shape of a cuboid and has in a first direction Z an extent L, in a second direction X an extent B, and in a third direction Y an extent D. The extent B in the second direction X is significantly greater, for example 5 to 10 times as large as the extent D in the third direction Y.

As shown FIG. 1 and FIG. 2, an electrode 3 which is connected to a first potential and in particular completely covers the bottom side is disposed on the bottom side of the substrate 2. The first potential may be connected to ground, as indicated schematically in FIG. 1.

Two electrodes 4, 5 having a triangular contour are arranged on the top side of the substrate 2 in FIGS. 1 and 2. The triangles of the electrodes are offset from each other by 180°, so that the apex of one triangle is flush with the base of the other triangle and vice versa. The two electrodes are only schematically illustrated, and may extend over almost the entire top side of the substrate 2, except for a narrow slot between them.

The first electrode 4 of the two electrodes is connected to a second potential, wherein a voltage +V may be applied between the second potential and the first potential. The second electrode 5 of the two electrodes is connected to a third potential, wherein a voltage −V may be applied between the third potential and the first potential. In particular, the absolute values of the voltages +V and −V may be identical.

The geometry of the electrodes 3, 4, 5, and the geometry of the substrate 2 and the voltage +V, −V are selected such that laser radiation entering the entrance face 6 is deflected in the X direction when a voltage is applied.

The substrate 2 has on its left side in FIG. 1 and FIG. 2 an entrance face 6, where the laser radiation to be deflected can enter. The substrate 2 has on its right side in FIG. 1 and FIG. 2 an exit face 7 from which the laser radiation to be deflected can exit. The entrance and the exit faces 6, 7 extend each in an X-Y plane and are spaced apart from one another in the Z-direction by a distance that corresponds to the extent L of the substrate 2 in the Z direction.

This extent L and the distance between the entrance face 6 and the exit face 7, respectively, is equal to the Talbot length L_{T} for the laser beam to be deflected. Therefore, L=L_{T}. The Talbot length (L_{T}) is defined by:

L_{T}=8 nD²/λ₀

wherein n is the refractive index of the waveguide 1 and the substrate 2 of the waveguide 1, respectively, D is the extent of the waveguide 1 and the substrate 2 of the waveguide 1, respectively, in the Y direction, and λ₀ is the vacuum wavelength of the laser radiation to be deflected.

Alternatively, the extent L and the distance between the entrance face 6 and the exit face 7 may be equal to a integer multiple of the Talbot length L_{T}. Alternatively, the extent L and of the distance between the entrance face 6 and the exit face 7 may be equal to one half of the Talbot length L_{T} or to an odd multiple of half the Talbot length L_{T}.

With this choice of the extent L and of the distance between the entrance face 6 and the exit face 7, respectively, relative to the Talbot length L_{T}, the laser radiation passing through the substrate 2 maintains its profile.

This is illustrated in FIG. 3. The laser radiation 8 is here incident on the entrance face 6 at an oblique angle from below and exits from the exit face 7 upwardly at an oblique angle. Thus, the laser radiation 8 does not change its original propagation direction in relation to the Y-direction, but is merely deflected relative to the X-direction through application of suitable voltages +V and −V.

In contrast, FIG. 4 shows the passage of a comparable laser radiation 8 through a waveguide 1′ according to the prior art. Since the extent L′ in the Z-direction herein corresponds neither to the Talbot length L_{T} nor to an integer multiple of the Talbot length L_{T}, nor to half of the Talbot length L_{T}, nor to an odd multiple of half the Talbot length L_{T}, the laser radiation 8 does not maintain its profile and diverges in the Y direction after exiting the exit face 7′. This is indicated in FIG. 4 by the laser radiation 8′ and 8″ propagating in two directions.

Because matching the extent L to the Talbot length L_{T} preserves the profile, two waveguide 1, 10 configured according to the invention can be arranged consecutively in the Z-direction, This is shown in FIGS. 5 and 6.

The laser radiation is deflected by the first waveguide 1 in the positive X direction, without causing an expansion of the laser radiation 8. Furthermore, the laser radiation 8 is unaffected in the Y-direction.

The laser radiation is deflected by the second waveguide 10 in the positive Y direction, without causing an expansion of the laser radiation 8. Furthermore, the laser radiation 8 is unaffected in the X-direction.

The laser radiation 8 is deflected both in the X and in the Y direction after passing through the two waveguides 1, 10, without causing a change in the profile of the laser radiation.

1-10. (canceled)

11. A device for deflecting laser radiation (8), comprising
at least one waveguide (1, 10) with an entrance face (6) and an exit face (7) for the laser radiation (8), wherein the entrance face (6) and the exit face (7) have a spacing (L) relative to one another in a first direction (Z), wherein the waveguide (1, 10) has a greater extent in a second direction perpendicular to the first vertical direction (X) than in a third direction perpendicular to the first and to the second vertical direction (Y);
at least two electrodes (3, 4, 5) which are arranged on or proximate to the at least one waveguide (1, 10), wherein a deflection voltage (+V, −V) can be applied the at least two electrodes (3, 4, 5), so that the laser radiation (8) in the at least one waveguide (1, 10) and/or when exiting from the at least one waveguide (1, 10) is electro-optically deflected in relation to at least the second direction (X),
wherein the spacing (L) between the entrance face (6) and the exit ace (7) of the at least one waveguide (1, 10) has a dimension in the first direction (Z) such that the profile of the laser radiation (8) after exiting from the exit face (7) corresponds to the profile of the laser beam (8) prior to entering the entrance face (6).

12. The device according to claim 11, wherein the spacing (L) between the entrance face (6) and the exit face (7) of the at least one waveguide (1, 10) in the first direction (Z) corresponds to a Talbot length (L_{T}) or to an integer multiple of a Talbot length (L_{T}) for light having the wavelength (λ₀) of the laser radiation (8) to be deflected.

13. The device according to claim 11, wherein the spacing (L) between the entrance face (6) and the exit face (7) of the at least one waveguide (1, 10) in the first direction (Z) corresponds to one half of a Talbot length (L_{T}), or to an odd multiple of half a Talbot length (L_{T}) for the light having the wavelength (λ₀) of the laser radiation be deflected.

14. The device according to claim 12, wherein the Talbot length (L_{T}) is defined by:
L_{T}=8 nD²/λ₀
wherein n is the refractive index of the at least one waveguide (1, 10),
D is the extent of the at least one waveguide (1, 10) in the third direction (Y), and
λ₀ the vacuum-wavelength of the laser radiation (8) to be deflected.

15. The device according to claim 11, wherein the extent (B) of the at least one waveguide (1, 10) in the second direction (X) is more than twice as large, preferably more than five times as large as the extent (D) in the third direction (Y).

16. The device according to claim 11, wherein at least one electrode (3, 4, 5) is directly or indirectly arranged in each case on two faces of the at least one waveguide (1, 10) that oppose one another in the third direction (Y).

17. The device according to claim 16, wherein two electrodes (4, 5) that are separated from one another are arranged on two faces of the at least one waveguide (1, 10) that oppose one another in the third direction (Y).

18. The device according to claim 11, wherein the device comprises two waveguides (1, 10) which are arranged sequentially so that the laser radiation (8) to be deflected can successively pass through the two waveguides (1, 10).

19. The device according to claim 18, wherein the two waveguides (1, 10) are rotated by 90° relative to each other in the first direction (Z) so that the device can deflect the laser radiation (8) in two mutually perpendicular directions (X, Y),

20. A laser device, comprising
a laser light source configured to emit laser radiation (8) with a wavelength (λ₀),
a device for deflecting the laser radiation (8),
wherein the device for deflecting laser radiation (8) is a device having at least one waveguide (1, 10) with an entrance face (6) and an exit face (7) for the laser radiation (8), wherein the entrance face (6) and the exit face (7) have a spacing (L) relative to one another in a first direction (Z), wherein the waveguide (1, 10) has a greater extent in a second direction perpendicular to the first vertical direction (X) than in a third direction perpendicular to the first and to the second vertical direction (Y); and
at least two electrodes (3, 4, 5) which are arranged on or proximate to the at least one waveguide (1, 10), wherein a deflection voltage (+V, −V) can be applied the at least two electrodes (3, 4, 5), so that the laser radiation (8) in the at least one waveguide (1, 10) and/or when exiting from the at least one waveguide (1, 10) is electro-optically deflected in relation to at least the second direction (X), and
wherein the spacing (L) between the entrance face (6) and the exit face (7) of the at least one waveguide (1, 10) has a dimension in the first direction (Z) such that the profile of the laser radiation (8) after exiting from the exit face (7) corresponds to the profile of the laser beam (8) prior to entering the entrance face (6).
